(19) United States
(12) Patent Application Publication
(10) Pub. No.: US 2026/0361006 A1
(43) Pub. Date: Nov. 12, 2026

(54) CONDUCTOR CONNECTING STRUCTURE

(71) Applicant: YAZAKI CORPORATION, Tokyo (JP)

(72) Inventor: Yasunori NABETA, Shizuoka (JP)

(73) Assignee: YAZAKI CORPORATION, Tokyo (JP)

(21) Appl. No.: 19/333,854

(22) Filed: Sep. 19, 2025

(30) Foreign Application Priority Data
Sep. 24, 2024 (JP) 2024-165169

(51) Int. Cl. H01R 4/62

(52) U.S. Cl. CPC H01R 4/625

(57) ABSTRACT

A conductor connecting structure includes a first conductor including a conductor portion including an end portion having a plate-like shape, and a second conductor including a conductor portion including an end portion having a plate-like shape. A width dimension and a thickness dimension at the end portion of the conductor portion of the first conductor are substantially the same as a width dimension and a thickness dimension at the end portion of the conductor portion of the second conductor, respectively. An end surface at the end portion of the conductor portion of the first conductor and an end surface at the end portion of the conductor portion of the second conductor are joined together by a joint portion, and the end portion of the conductor portion of the first conductor and the end portion of the conductor portion of the second conductor are not joined together in a state of being stacked on each other in a thickness direction. In a plan view of the first conductor and the second conductor, a total line length of the joint portion is 1.7 times or more than the shorter one of the width dimension at the end portion of the conductor portion of the first conductor and the width dimension at the end portion of the conductor portion of the second conductor.

### CROSS-REFERENCE TO RELATED APPLICATIONS

The present application is based on, and claims priority from Japanese Patent Application No. 2024-165169, filed on Sep. 24, 2024, the entire contents of which are incorporated herein by reference.

### TECHNICAL FIELD

The present disclosure relates to a conductor connecting structure.

### BACKGROUND

Various types of electronic devices are mounted in automobiles, and wire harnesses are routed for supplying electric power and transmitting control signals and the like to the electronic devices. A wire harness includes a plurality of electric wires and connectors, and is connected to an electronic device or another wire harness by fitting the connectors into connectors of the electronic device or connectors of the other wire harness.

An electric wire with a terminal (electric wire with a conductor) forming such a wire harness generally includes an electric wire and a terminal fitting (conductor) attached to a terminal end of the electric wire (see Japanese Unexamined Patent Application Publication No. 2018-190617 A).

Japanese Unexamined Patent Application Publication No. 2018-190617 A discloses an electric wire with a terminal, the electric wire including an electric wire that includes a conductor portion made of a material mainly composed of a first metal and covered with an insulating material, and a terminal that is made of a material mainly composed of a second metal different from the first metal and connected to the conductor portion exposed at one end of the electric wire. In the electric wire with a terminal, an alloy layer containing the first metal and the second metal is further formed across the conductor portion and the terminal along an entire outer peripheral edge of a contact portion between the conductor portion and the terminal. Specifically, in a state where the conductor portion including a plurality of element wires and the terminal abut against each other, the contact portion between the conductor portion and the terminal is joined by a laser welding machine. In this manner, a joint portion between the conductor portion and the terminal is formed as an alloy layer, and thus the conductor portion and the terminal are electrically connected to each other and firmly joined together.

### SUMMARY OF THE INVENTION

In Japanese Unexamined Patent Application Publication No. 2018-190617 A, a plate-like terminal and a conductor portion having a substantially rectangular parallelepiped shape are joined together in an abutting state. Therefore, in order to secure conduction between the terminal and the conductor portion, it is necessary to melt the entire abutting portion. However, in a case in which the plate-like terminal and the conductor portion of the electric wire are made of different metals, even when the entire abutting portion is melted, conductivity between the terminal and the conductor portion of the electric wire may be insufficient due to different electrical conductivities of the respective metals.

The present disclosure has been made in view of such a problem in the related art. Further, an object of the present disclosure is to provide a conductor connecting structure capable of enhancing electroconductivity of a joint portion even when two conductors made of different materials are joined together.

A conductor connecting structure according to an aspect of the present disclosure includes a first conductor including a conductor portion including an end portion having a plate-like shape, and a second conductor including a conductor portion including an end portion having a plate-like shape. A width dimension and a thickness dimension at the end portion of the conductor portion of the first conductor are substantially the same as a width dimension and a thickness dimension at the end portion of the conductor portion of the second conductor, respectively. An end surface at the end portion of the conductor portion of the first conductor and an end surface at the end portion of the conductor portion of the second conductor are joined together by a joint portion, and the end portion of the conductor portion of the first conductor and the end portion of the conductor portion of the second conductor are not joined together in a state of being stacked on each other in a thickness direction. In a plan view of the first conductor and the second conductor, a total line length of the joint portion is 1.7 times or more than the shorter one of the width dimension at the end portion of the conductor portion of the first conductor and the width dimension at the end portion of the conductor portion of the second conductor.

According to the present disclosure, it is possible to provide a conductor connecting structure capable of enhancing electroconductivity of a joint portion even when two conductors made of different materials are joined together.

### BRIEF DESCRIPTION OF DRAWINGS

FIG. 1 is a perspective view schematically illustrating an example of a conductor connecting structure according to the present embodiment.

FIG. 2 is a plan view schematically illustrating another example of the conductor connecting structure according to the present embodiment.

FIG. 3 is a plan view schematically illustrating another example of the conductor connecting structure according to the present embodiment.

FIG. 4 is a perspective view schematically illustrating another example of the conductor connecting structure according to the present embodiment.

FIG. 5A, FIG. 5B, and FIG. 5C are schematic views for describing a method of manufacturing the conductor connecting structure according to the present embodiment.

FIG. 6A and FIG. 6B are schematic perspective views for describing a reason why a total line length of a joint portion is 1.7 times or more than the shorter one of a width dimension at an end portion of a conductor portion of a first conductor and a width dimension at an end portion of a conductor portion of a second conductor.

### DETAILED DESCRIPTION OF THE INVENTION

With reference to the drawings, a conductor connecting structure according to the present embodiment is described below in detail. Note that the dimensional ratios in the drawings are exaggerated for explanatory purposes, and may differ from the actual ratios.

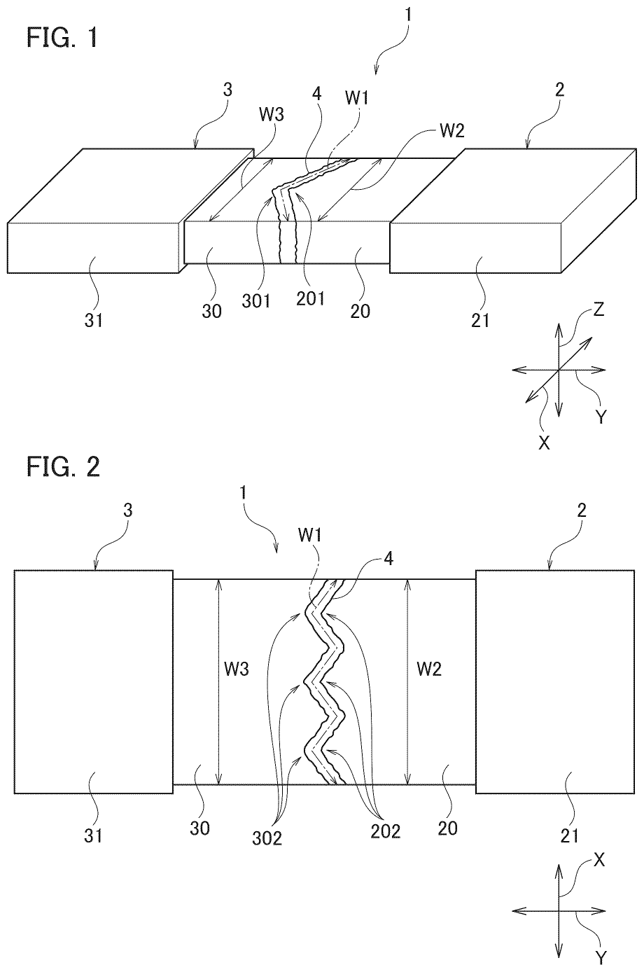

As illustrated in FIG. 1, a conductor connecting structure 1 according to the present embodiment includes a first conductor 2 including a conductor portion 20 including an end portion having a plate-like shape and a second conductor 3 including a conductor portion 30 including an end portion having a plate-like shape. Note that, in this specification and the drawings, a direction in which the first conductor 2 and the second conductor 3 are arrayed is indicated with an arrow Y, a direction (an up-down direction) orthogonal to the arrow Y is indicated with an arrow Z, and a direction (a left-right direction) orthogonal to the arrow Y and the arrow Z is indicated with an arrow X.

The first conductor 2 includes the conductor portion 20 formed of a metal having electroconductivity and an insulating coating layer 21 covering the periphery of the conductor portion 20. The conductor portion 20 is a member including at least an end portion having a plate-like shape. The insulating coating layer 21 is formed of a resin material having flexibility and an electrical insulation property. Further, at one end of the first conductor 2, the insulating coating layer 21 is removed to expose the end portion of the conductor portion 20. Examples of the first conductor 2 may include a bus bar and a terminal.

The second conductor 3 also includes the conductor portion 30 formed of a metal having electroconductivity and an insulating coating layer 31 covering the periphery of the conductor portion 30. The conductor portion 30 is a member including at least an end portion having a plate-like shape. The insulating coating layer 31 is formed of a resin material having flexibility and an electrical insulation property. Further, at one end of the second conductor 3, the insulating coating layer 31 is also removed to expose the end portion of the conductor portion 30. Examples of the second conductor 3 may include a bus bar and a terminal.

The conductor portion 20 of the first conductor 2 and the conductor portion 30 of the second conductor 3 are formed by processing a plate material formed of an electrically conductive metal material. Note that the conductor portion 20 of the first conductor 2 and the conductor portion 30 of the second conductor 3 may be formed of a single-layer metal plate, or may be formed of a laminated plate in which a plurality of thin metal plates are stacked.

The electrically conductive metal material forming the conductor portion 20 of the first conductor 2 and the conductor portion 30 of the second conductor 3 is not particularly limited, but copper, a copper alloy, aluminum, or an aluminum alloy may be used, for example. Specifically, any one of the conductor portion 20 of the first conductor 2 and the conductor portion 30 of the second conductor 3 may be formed of aluminum or an aluminum alloy. Further, any one of the conductor portion 20 of the first conductor 2 and the conductor portion 30 of the second conductor 3 may be formed of copper or a copper alloy. Note that one of the conductor portion 20 of the first conductor 2 and the conductor portion 30 of the second conductor 3 may be formed of copper or a copper alloy, and the other of the conductor portion 20 of the first conductor 2 and the conductor portion 30 of the second conductor 3 may be formed of aluminum or an aluminum alloy.

A thickness dimension of the conductor portion 20 of the first conductor 2 in the Z direction is substantially the same as a thickness dimension of the conductor portion 30 of the second conductor 3 in the Z direction. The thickness dimension of the conductor portion 20 of the first conductor 2 is preferably within ±30% with respect to the thickness dimension of the conductor portion 30 of the second conductor 3. Note that the thickness dimension of the conductor portion 20 of the first conductor 2 and the thickness dimension of the conductor portion 30 of the second conductor 3 are not particularly limited, and may fall within a range from 3 mm to 6 mm, for example.

A width dimension of the conductor portion 20 of the first conductor 2 in the X direction is substantially the same as a width dimension of the conductor portion 30 of the second conductor 3 in the X direction. The width dimension of the conductor portion 20 of the first conductor 2 is preferably within ±30% with respect to the width dimension of the conductor portion 30 of the second conductor 3.

Note that the first conductor 2 and the second conductor 3 may each include a plate spring, a projection, a through hole, or the like formed thereon so as to prevent the first conductor 2 and the second conductor 3 from coming off when inserted into a connector or the like.

The conductor portion 20 of the first conductor 2 includes a projection portion 201 that protrudes toward the conductor portion 30 of the second conductor 3. Further, the projection portion 201 has a substantially triangular shape in a plan view. Further, the conductor portion 30 of the second conductor 3 includes a recess portion 301 in conformity with the shape of the projection portion 201. Further, the recess portion 301 has a substantially triangular shape in a plan view. Thus, the projection portion 201 of the conductor portion 20 of the first conductor 2 has a structure that is meshed with the recess portion 301 of the conductor portion 30 of the second conductor 3.

Further, in a state where an end surface of the projection portion 201 of the conductor portion 20 of the first conductor 2 and the end surface of the recess portion 301 of the conductor portion 30 of the second conductor 3 abut against each other, the boundary surfaces between the projection portion 201 and the recess portion 301 are joined together. As a result, a joint portion 4 is formed. The joint portion 4 is formed from a front surface to a back surface of the conductor portion 20 of the first conductor 2 and the conductor portion 30 of the second conductor 3 in the Z direction being a thickness direction. Further, the joint portion 4 is formed from one end to the other end of the conductor portion 20 of the first conductor 2 and the conductor portion 30 of the second conductor 3 in the X direction being a width direction.

Herein, in a plan view of the first conductor 2 and the second conductor 3, a total line length W1 of the joint portion 4 is 1.7 times or more than the shorter one of a width dimension W2 at the end portion of the conductor portion 20 of the first conductor 2 and a width dimension W3 at the end portion of the conductor portion 30 of the second conductor 3. When the line length W1 is 1.7 times or more than the shorter one of the width dimension W2 and the width dimension W3, the electrically conductive area between the conductor portion 20 of the first conductor 2 and the conductor portion 30 of the second conductor 3 is increased, and hence electroconductivity of the joint portion 4 can be enhanced.

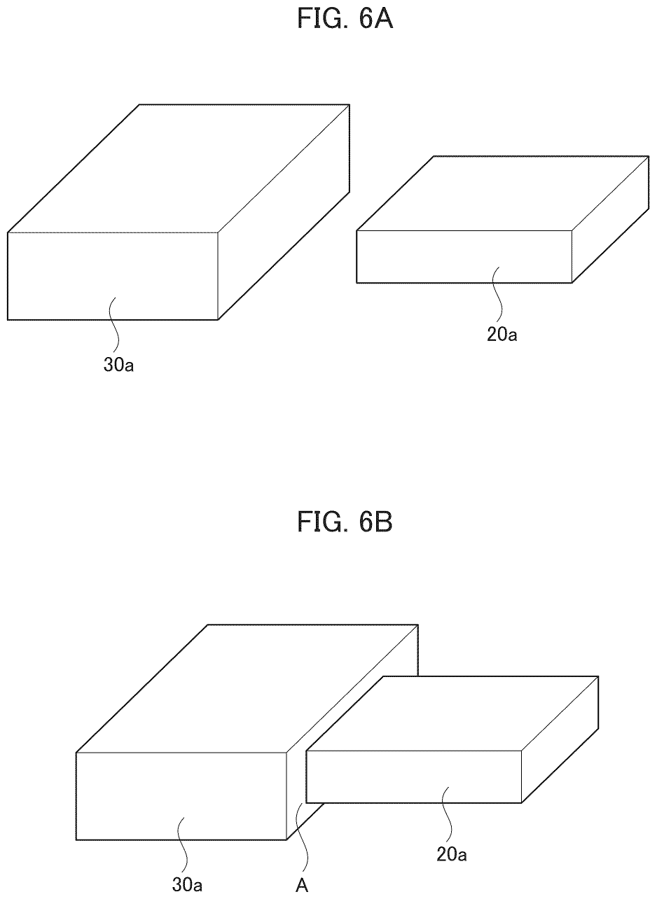

Specifically, the electrical conductivity of aluminum (IACS) is 61.7% with respect to that of copper. Thus, in a case in which the conductor portion of the first conductor is formed of copper, and the conductor portion of the second conductor is formed of aluminum, when an electric current is caused to flow similarly through the conductor portion of the first conductor and the conductor portion of the second conductor, the area of the end surface of the conductor portion of the second conductor is required to be 1.7 times or more than the area of the end surface of the conductor portion of the first conductor. Further, in a case in which it is assumed that, as illustrated in FIG. 6A, an end surface of a conductor portion 20a of the first conductor 2 and an end surface of a conductor portion 30a of the second conductor 3 are flat surfaces, even when the end surface of the conductor portion 20a and the end surface of the conductor portion 30a abut against each other with a joint efficiency of 100%, only 61.7% of the area of the end surface of the conductor portion 30a is joined to the end surface of the conductor portion 20a. In other words, as illustrated in FIG. 6B, a part indicated with the reference symbol A at the end surface of the conductor portion 30a of the second conductor 3 does not contact with the conductor portion 20a of the first conductor 2. Thus, at a joint portion between the conductor portion 20a of the first conductor 2 and the conductor portion 30a of the second conductor 3, there is a concern that electrical and mechanical performance may be degraded.

In contrast, in the conductor connecting structure 1 of the present embodiment, the total line length W1 of the joint portion 4 is 1.7 times or more than the shorter one of the width dimension W2 at the end portion of the conductor portion 20 of the first conductor 2 and the width dimension W3 at the end portion of the conductor portion 30 of the second conductor 3. Further, the width dimension W2 and the thickness dimension at the end portion of the conductor portion 20 of the first conductor 2 are substantially the same as the width dimension W3 and the thickness dimension at the end portion of the conductor portion 30 of the second conductor 3, respectively. Thus, even when the conductor portion 20 of the first conductor 2 is formed of copper, and the conductor portion 30 of the second conductor 3 is formed of aluminum, the joint area between the conductor portion 20 and the conductor portion 30 is equal to the area of the end surface of the conductor portion 30, and hence degradation of electrical performance can be suppressed. Further, the joint area between the conductor portion 20 and the conductor portion 30 is equal to the area of the end surface of the conductor portion 30, and hence the mechanical strength of the joint portion 4 between the conductor portion 20 and the conductor portion 30 can be enhanced.

Note that, when the width dimension W2 at the end portion of the conductor portion 20 of the first conductor 2 and the width dimension W3 at the end portion of the conductor portion 30 of the second conductor 3 are the same, the total line length W1 of the joint portion 4 is 1.7 times or more than one of the width dimension W2 and the width dimension W3.

In the conductor connecting structure 1 of the present embodiment, the total line length W1 of the joint portion 4 is only required to be 1.7 times or more than the shorter one of the width dimension W2 and the width dimension W3. Thus, the shapes of the end portion of the conductor portion 20 of the first conductor 2 and the end portion of the conductor portion 30 of the second conductor 3 are not limited to the shapes illustrated in FIG. 1.

For example, in the conductor connecting structure 1 illustrated in FIG. 2, the conductor portion 20 of the first conductor 2 includes a plurality of projection portions 202 that protrude toward the conductor portion 30 of the second conductor 3. Further, each of the projection portions 202 has a substantially triangular shape in a plan view. Further, the conductor portion 30 of the second conductor 3 includes recess portions 302 in conformity with the shapes of the plurality of projection portions 202. Further, each of the recess portions 302 has a substantially triangular shape in a plan view. Thus, the plurality of projection portions 202 of the conductor portion 20 of the first conductor 2 have a structure meshed with the plurality of recess portions 302 of the conductor portion 30 of the second conductor 3.

Further, in a state where the end surfaces of the plurality of projection portions 202 of the conductor portion 20 of the first conductor 2 and the end surfaces of the plurality of recess portions 302 of the conductor portion 30 of the second conductor 3 abut against each other, the boundary surfaces between the projection portion 202 and the recess portion 302 are joined together. As a result, the joint portion 4 can be formed. In such a structure, the total line length W1 of the joint portion 4 can be 1.7 times or more than the shorter one of the width dimension W2 at the end portion of the conductor portion 20 of the first conductor 2 and the width dimension W3 at the end portion of the conductor portion 30 of the second conductor 3.

Further, as illustrated in FIG. 1, when there is provided one projection portion 201 of the conductor portion 20 of the first conductor 2, it is required to increase the projection length of the projection portion 201 in the Y direction to some extent so that the line length W1 of the joint portion 4 is 1.7 times or more than the shorter one of the width dimension W2 and the width dimension W3. However, as illustrated in FIG. 2, there are provided the plurality of projection portions 201 of the conductor portion 20 of the first conductor 2, and hence the projection length of the projection portion 201 in the Y direction may be short. Thus, the projection length of the joint portion 4 in the Y direction can be reduced.

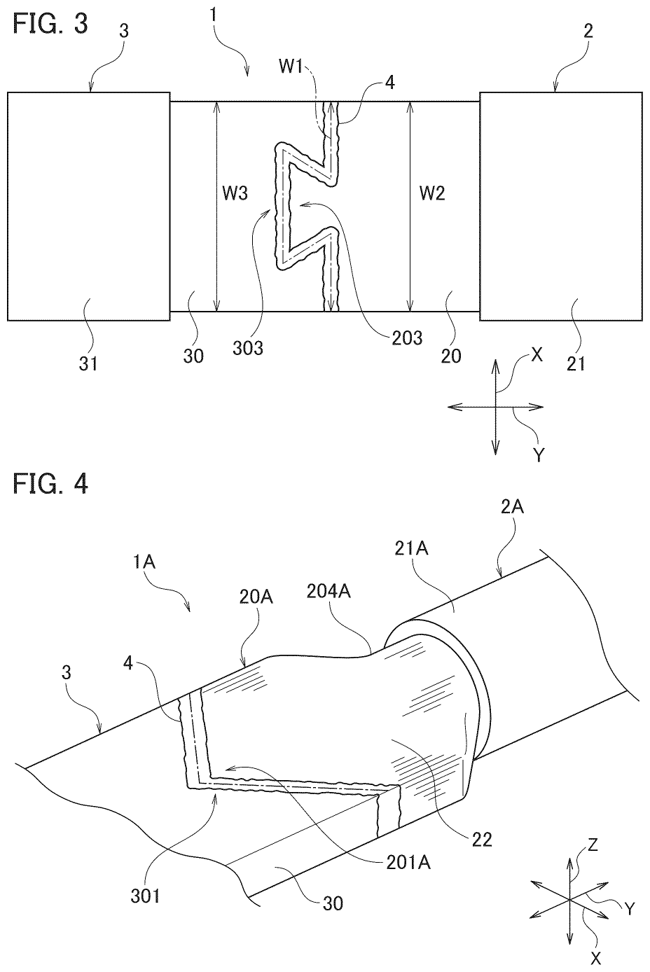

In the conductor connecting structure 1 illustrated in FIG. 3, the conductor portion 20 of the first conductor 2 includes a projection portion 203 that protrudes toward the conductor portion 30 of the second conductor 3, and the conductor portion 30 of the second conductor 3 includes a recess portion 303 in conformity with the shape of the projection portion 203. Further, in the conductor portion 20 of the first conductor 2, a dovetail serving as the projection portion 203 having a substantially trapezoidal shape in a plan view is formed. In the conductor portion 30 of the second conductor 3, a dovetail groove serving as the recess portion 303 in conformity with the shape of the dovetail is formed. Further, after the projection portion 203 and the recess portion 303 are fitted to each other, the boundary surfaces between the projection portion 202 and the recess portion 302 are joined together. As a result, the joint portion 4 can be formed. With this dovetail joint structure, the total line length W1 of the joint portion 4 can be 1.7 times or more than the shorter one of the width dimension W2 at the end portion of the conductor portion 20 of the first conductor 2 and the width dimension W3 at the end portion of the conductor portion 30 of the second conductor 3.

In the conductor connecting structure 1 of the present embodiment, the first conductor 2 and the second conductor 3 are not particularly limited in shape as long as the end portion of each of the conductor portions has a plate-like shape. For example, the conductor portion 20 of the first conductor 2 and the conductor portion 30 of the second conductor 3 may be hollow or solid. Further, at least one of the first conductor 2 and the second conductor 3 may be an electric wire.

FIG. 4 illustrates the conductor connecting structure 1 in which the first conductor is an electric wire 2A. In the conductor connecting structure 1 in FIG. 4, the electric wire 2A is a coating electric wire including a plurality of element wires 20A each serving as a conductor portion and an insulating coating layer 21A covering the periphery of the plurality of element wires 20A. The element wires 20A may be formed of an electrically conductive metal material such as copper, a copper alloy, aluminum, and an aluminum alloy. The insulating coating layer 21A is formed of a resin material having flexibility and an electrical insulation property. Further, at one end of the electric wire 2A, the insulating coating layer 21A is removed to expose a part of the element wires 20A.

The electric wire 2A includes a core wire bundle 22 that is formed by shaping the plurality of element wires 20A being exposed and has a substantially rectangular shape in a plan view. Note that the core wire bundle 22 corresponds to the end portion of the conductor portion 20 of the first conductor 2. Further, an inclination surface 204A is formed between the plurality of element wires 20A around which the insulating coating layer 21A is provided and the core wire bundle 22.

The core wire bundle 22 of the electric wire 2A includes a projection portion 201A that protrudes toward the conductor portion 30 of the second conductor 3. Further, the projection portion 201A has a substantially triangular shape in a plan view. Further, the conductor portion 30 of the second conductor 3 includes the recess portion 301 in conformity with the shape of the projection portion 201A. Further, the recess portion 301 has a substantially triangular shape in a plan view. Thus, the projection portion 201A of the core wire bundle 22 of the electric wire 2A has a structure of being meshed with the recess portion 301 of the conductor portion 30 of the second conductor 3.

Further, in a state where the end surface of the projection portion 201A of the core wire bundle 22 of the electric wire 2A and the end surface of the recess portion 301 of the conductor portion 30 of the second conductor 3 abut against each other, the boundary surfaces between the projection portion 201A and the recess portion 301 are joined together. As a result, the joint portion 4 is formed. The joint portion 4 is formed from a front surface to a back surface of the core wire bundle 22 of the electric wire 2A and the conductor portion 30 of the second conductor 3 in the Z direction being a thickness direction. Further, the joint portion 4 is formed from one end to the other end of the core wire bundle 22 of the electric wire 2A and the conductor portion 30 of the second conductor 3 in the X direction being a width direction. Note that the joint portion 4 is a part formed of the metal forming the element wires 20A of the electric wire 2A and the metal forming the conductor portion 30 of the second conductor 3.

In this manner, in the conductor connecting structure 1A of the present embodiment, the first conductor 2 may be configured as the electric wire 2A including the core wire bundle 22 formed of the plurality of element wires 20A, and the end portion of the conductor portion 20 of the first conductor 2 may be formed of the core wire bundle 22.

Next, a method of manufacturing the conductor connecting structure 1 according to the present embodiment is described.

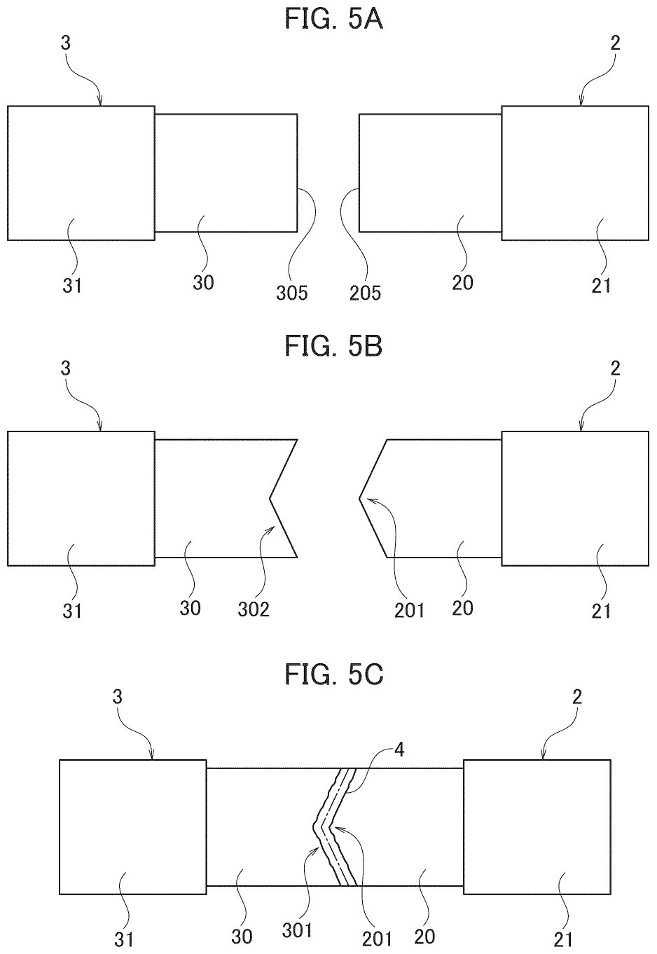

As illustrated in FIG. 5A, first, the first conductor 2 including the conductor portion 20 including the end portion having a plate-like shape and the second conductor 3 including the conductor portion 30 including the end portion having a plate-like shape are prepared.

Subsequently, as illustrated in FIG. 5B, an end surface 205 of the conductor portion 20 of the first conductor 2 is processed to have a projection shape. As a result, the projection portion 201 is formed. Further, an end surface 305 of the conductor portion 30 of the second conductor 3 is processed to have a recess shape. As a result, the recess portion 301 is formed.

Further, as illustrated in FIG. 5C, in a state where the end surface of the projection portion 201 of the conductor portion 20 of the first conductor 2 and the end surface of the recess portion 301 of the conductor portion 30 of the second conductor 3 abut against each other, the boundary surfaces between the projection portion 201 and the recess portion 301 are joined together. As a result, the joint portion 4 is formed. The joining method is not particularly limited, but a joining technique such as FSW (friction stir welding) and heating pressure welding may be used. Further, laser welding may also be used as the joining method. Note that, in a case of a dovetail joint structure as illustrated in FIG. 3, the projection portion 201 of the conductor portion 20 of the first conductor 2 can be joined to the recess portion 301 of the conductor portion 30 of the second conductor 3 by a method of press-fitting.

By such a manufacturing method, the conductor connecting structure 1 in which the total line length W1 of the joint portion 4 is 1.7 times or more than the shorter one of the width dimension W2 and the width dimension W3 can be obtained. Further, the end portion of the conductor portion 20 of the first conductor 2 and the end portion of the conductor portion 30 of the second conductor 3 each have a plate-like shape, and hence the projection portion 201 and the recess portion 301 can be formed by press working. With this, the projection portion 201 and the recess portion 301 can be processed into a uniform shape.

As described above, the conductor connecting structure 1 of the present embodiment includes the first conductor 2 including the conductor portion 20 including the end portion having a plate-like shape and the second conductor 3 including the conductor portion 30 including the end portion having a plate-like shape. The width dimension and the thickness dimension at the end portion of the conductor portion 20 of the first conductor 2 are substantially the same as the width dimension and the thickness dimension at the end portion of the conductor portion 30 of the second conductor 3, respectively. The end surface at the end portion of the conductor portion 20 of the first conductor 2 and the end surface at the end portion of the conductor portion 30 of the second conductor 3 are joined together by the joint portion 4, and the end portion of the conductor portion 20 of the first conductor 2 and the end portion of the conductor portion 30 of the second conductor 3 are not joined together in a state of being stacked on each other in a thickness direction. Further, in a plan view of the first conductor 2 and the second conductor 3, the total line length W1 of the joint portion 4 is 1.7 times or more than the shorter one of the width dimension W2 at the end portion of the conductor portion 20 of the first conductor 2 and the width dimension W3 at the end portion of the conductor portion 30 of the second conductor 3.

In the conductor connecting structure 1, the total line length W1 of the joint portion 4 is 1.7 times or more than the shorter one of the width dimension W2 at the end portion of the conductor portion 20 of the first conductor 2 and the width dimension W3 at the end portion of the conductor portion 30 of the second conductor 3. Thus, the joint area between the conductor portion 20 and the conductor portion 30 is equal to the area of the end surface of the conductor portion 30, and hence degradation of electrical performance can be suppressed. Further, the joint area between the conductor portion 20 and the conductor portion 30 is equal to the area of the end surface of the conductor portion 30, and hence the mechanical strength of the joint portion 4 between the conductor portion 20 and the conductor portion 30 can be improved. As a result, the reliability of the joint portion 4 between the conductor portion 20 of the first conductor 2 and the conductor portion 30 of the second conductor 3 can be secured.

Further, in the conductor connecting structure 1, the end surface at the end portion of the conductor portion 20 of the first conductor 2 and the end surface at the end portion of the conductor portion 30 of the second conductor 3 are joined together by the joint portion 4, and the end portion of the conductor portion 20 of the first conductor 2 and the end portion of the conductor portion 30 of the second conductor 3 are not joined together in a state of being stacked on each other in a thickness direction. Thus, the thickness of the joint portion between the conductor portion 20 of the first conductor 2 and the conductor portion 30 of the second conductor 3 is reduced, and hence the conductor connecting structure 1 can be reduced in height.

In the conductor connecting structure 1 of the present embodiment, it is preferred that at least one projection portion 201 be formed at one of the end portion of the conductor portion 20 of the first conductor 2 and the end portion of the conductor portion 30 of the second conductor 3, and the recess portion 301 that is meshed with the projection portion 201 be formed at the other of the end portion of the conductor portion 20 of the first conductor 2 and the end portion of the conductor portion 30 of the second conductor 3. With this configuration, the total line length W1 of the joint portion 4 can be 1.7 times or more than the shorter one of the width dimension W2 at the end portion of the conductor portion 20 of the first conductor 2 and the width dimension W3 at the end portion of the conductor portion 30 of the second conductor 3. Note that FIG. 1 to FIG. 5C illustrate a configuration in which the projection portion 201 is formed at the end portion of the conductor portion 20 of the first conductor 2, and the recess portion 301 is formed at the end portion of the conductor portion 30 of the second conductor 3. However, the present embodiment is not limited to such a configuration. Even in a configuration in which a recess portion is formed at the end portion of the conductor portion 20 of the first conductor 2, and a projection portion is formed at the end portion of the conductor portion 30 of the second conductor 3, the above-mentioned effects can be achieved.

In the conductor connecting structure 1 of the present embodiment, the first conductor 2 may be configured as an electric wire including the core wire bundle 22 formed of the plurality of element wires 20A, and the end portion of the conductor portion 20 of the first conductor 2 may be formed of the core wire bundle 22. With this, when a terminal is used as the second conductor 3, an electric wire with a terminal in which excellent electroconductivity and connection strength are exerted between the second conductor 3 and the first conductor 2 can be achieved.

In the conductor connecting structure 1 of the present embodiment, one of the conductor portion 20 of the first conductor 2 and the conductor portion 30 of the second conductor 3 may be formed of copper or a copper alloy, and the other of the conductor portion 20 of the first conductor 2 and the conductor portion 30 of the second conductor 3 may be formed of aluminum or an aluminum alloy. In the conductor connecting structure 1, the joint area between the conductor portion 20 of the first conductor 2 and the conductor portion 30 of the second conductor 3 is equal to the area of the end surface of the conductor portion 30 of the second conductor 3, and hence degradation of electrical performance can be suppressed between the first conductor 2 and the second conductor 3. Thus, even when the metals described above are used as the conductor portion 20 of the first conductor 2 and the conductor portion 30 of the second conductor 3, satisfactory conduction therebetween can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A conductor connecting structure comprising:
a first conductor including a conductor portion including an end portion having a plate-like shape; and
a second conductor including a conductor portion including an end portion having a plate-like shape, wherein
a width dimension and a thickness dimension at the end portion of the conductor portion of the first conductor are substantially the same as a width dimension and a thickness dimension at the end portion of the conductor portion of the second conductor, respectively,
an end surface at the end portion of the conductor portion of the first conductor and an end surface at the end portion of the conductor portion of the second conductor are joined together by a joint portion, and the end portion of the conductor portion of the first conductor and the end portion of the conductor portion of the second conductor are not joined together in a state of being stacked on each other in a thickness direction, and
in a plan view of the first conductor and the second conductor, a total line length of the joint portion is 1.7 times or more than the shorter one of the width dimension at the end portion of the conductor portion of the first conductor and the width dimension at the end portion of the conductor portion of the second conductor.

2. The conductor connecting structure according to claim 1, wherein at least one projection portion is formed at one of the end portion of the conductor portion of the first conductor and the end portion of the conductor portion of the second conductor, and
a recess portion is formed at the other of the end portion of the conductor portion of the first conductor and the end portion of the conductor portion of the second conductor, the recess portion being meshed with the projection portion.

3. The conductor connecting structure according to claim 1, wherein the first conductor is an electric wire including a core wire bundle formed of a plurality of element wires, and the end portion of the conductor portion of the first conductor is formed of the core wire bundle.

4. The conductor connecting structure according to claim 1, wherein one of the conductor portion of the first conductor and the conductor portion of the second conductor is formed of copper or a copper alloy, and the other of the conductor portion of the first conductor and the conductor portion of the second conductor is formed of aluminum or an aluminum alloy.
